(19) United States
(12) Patent Application Publication
(10) Pub. No.: US 2017/0102788 A1
(43) Pub. Date: Apr. 13, 2017

(54) DETACHABLE OPERATIONAL DEVICE

(71) Applicants: DENSO International America, Inc., Southfield, MI (US); DENSO CORPORATION, Kariya-city (JP)

(72) Inventors: Marc Arceo, Livonia, MI (US); Gareth Webb, Farmington, MI (US); Cary Horvath, Dearborn, MI (US); Michael Lozano, Detroit, MI (US)

(21) Appl. No.: 14/880,598

(22) Filed: Oct. 12, 2015

(51) Int. Cl. G06F 3/0362; G06F 3/01

(52) U.S. Cl. CPC G06F 3/0362; G06F 3/016

(57) ABSTRACT

An operational element may receive manipulation. An encoder may detect the manipulation of the operational element and may send a detection signal representing the manipulation. A bezel may receive the operational element. A clip may be coupled with the bezel. The clip may be detachably affixed to a screen of a display device.

### TECHNICAL FIELD

The present disclosure relates to a detachable operational device. The present disclosure further relates to a graphic image controller.

### BACKGROUND

For example, a user may use various infotainment devices to manipulate the infotainment device and/or to retrieve information on the infotainment device. An infotainment device may produce a haptic sense on a user when the user manipulates the infotainment device.

### SUMMARY

According to an aspect of the preset disclosure, an operational element may be configured to receive manipulation. An encoder may be configured to detect the manipulation of the operational element and to send a detection signal representing the manipulation. A bezel may be configured to receive the operational element. At least one clip may be coupled with the bezel and may be configured to be affixed to a screen of a display device.

### BRIEF DESCRIPTION OF THE DRAWINGS

The above and other objects, features and advantages of the present invention will become more apparent from the following detailed description made with reference to the accompanying drawings. In the drawings:

FIG. 1 is an exploded view showing components of an operational device of a first embodiment;

FIG. 2 is a diagram showing connection among components of the operational device and a display device;

FIG. 3 is an exploded view showing the components of the operational device;

FIG. 4 is a perspective view showing the operational device;

FIG. 5 is a perspective view showing the operational device to be attached to the display device;

FIG. 6 is a perspective view showing the operational device attached to the display device;

FIG. 7 is a flowchart showing a processing of the display device;

FIGS. 8 to 9 are top views showing a first example;

FIGS. 10 to 11 are top views showing a second example;

FIGS. 12 to 13 are top views showing a third example;

FIG. 14 is a perspective view showing an operational device of a second embodiment;

FIG. 15 is a perspective view showing an operational device of a third embodiment; and

FIG. 16 is a perspective view showing an operational device of a fourth embodiment.

### DETAILED DESCRIPTION

### First Embodiment

As follows, a first embodiment of the present disclosure will be described with reference to drawings. In the description, a height direction is along an arrow represented by “HEIGHT” in drawing(s). A radial direction is along an arrow represented by “RADIAL” in drawing(s). A circumferential direction is along an arrow represented by “CIRCUMFERENTIAL” in drawing(s).

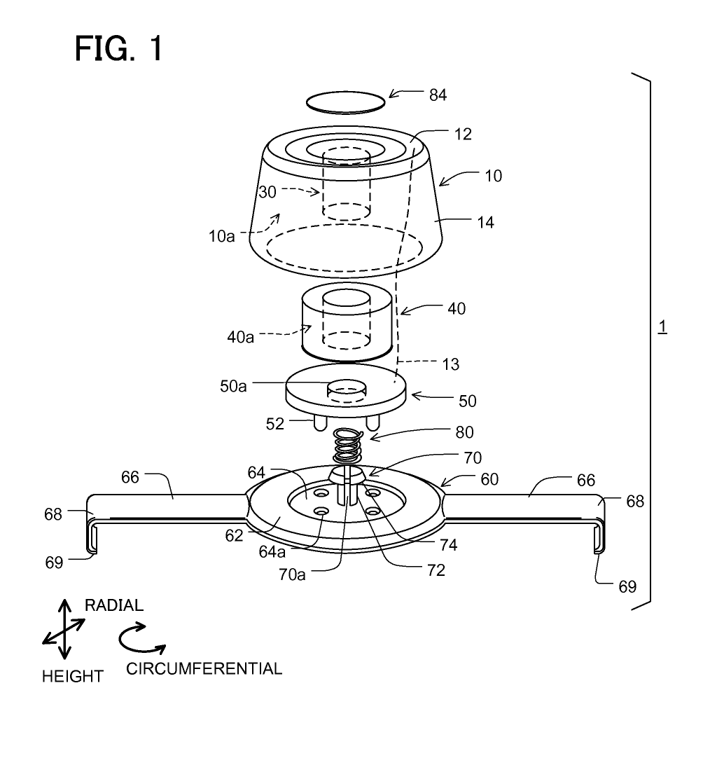

As shown in FIG. 1, an operational device 1 may include a knob 10, an electronic module 30, a cylinder magnet 40, a base 50, a bezel 60, and a spring 80. The knob 10 may function as an operational element.

The knob 10 may include a top wall 12 and a sidewall 14. The top wall 12 may be in a circular plate shape and may be formed of electrically conductive material such as metal. The top wall 12 may be equipped with an electrically conductive wire 13. The sidewall 14 may be in a tubular shape extending in the circumferential direction. The sidewall 14 may be molded of an opaque plastic material by injection molding. The opaque plastic material may be, for example, ABS resin. The knob 10 may reduce in diameter from a bottom side toward the top wall 12 to form a chamfered conical shape. The top wall 12 and the sidewall 14 may be integrated into a hollow one piece to form an internal space 10a.

The top wall 12 may be equipped with a solar cell 84, which is configured to generate electric power when receiving light ray such as sun light and/or fluorescent light. The solar cell 84 may be equipped on a printed circuit board. The solar cell 84 may be electrically connected with the electronic module 30. The solar cell 84 may be equipped with a shield such as a plate-shaped grass.

In another example, the top wall 12 and the sidewall 14 may be integrally molded of an opaque plastic material by injection molding.

The electronic module 30 may be in a columnar shape having a circular cross section. The electronic module 30 may extend from a bottom surface of the top wall 12 into the internal space 10a.

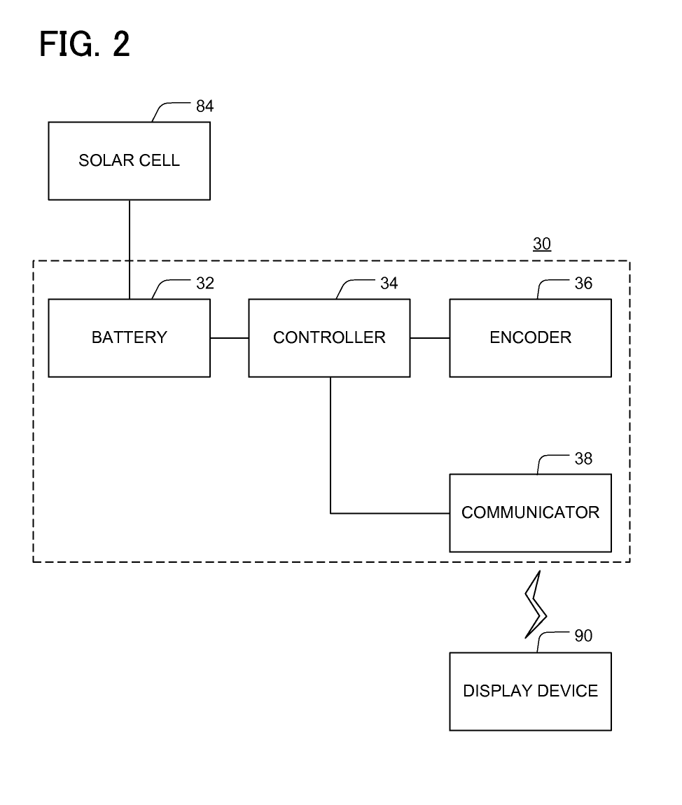

In FIG. 2, the electronic module 30 may include a battery 32, a controller 34, an encoder 36, and a communicator 38, which are electrically connected with each other. The battery 32 may be a power cell, such as a capacitor and/or a lithium ion cell. The battery 32 may be connected with the solar cell 84 to receive electric power generated with the solar cell 84 and to store the received electric power. In another example, the battery 32 may have a USB connector connectable with another power source. The controller 34 may be a microcomputer configured with a CPU and a storage device for implementing various processings. The controller 34 may receive electric power from the battery 32. The encoder 36 may include a hall element to generate a detection signal according to an intensity of a magnetic flux passing therethrough. The encoder 36 may transmit the detection signal to the controller 34. The communicator 38 may be communicable with another device in a wireless manner. The communicator 38 may enable the controller 34 to exchange information with another device. The communicator 38 may be paired with another wireless device to establish a wireless communication therebetween.

The cylinder magnet 40 may be in a tubular shape and may include a magnet molded with resin to generate multiple magnetic fluxes inward in the radial direction. The cylinder magnet 40 may have a shaft hole 40a equipped with a bearing (not shown) to support the electronic module 30 rotationally. In another example, the electronic module 30 may be fitted with the shaft hole 40a of the cylinder magnet 40 rotationally via lubricant.

The base 50 may be in a disc shape and may be integrally formed of conductive material such as metal. The base 50 may be connected with the top wall 12 through the conductive wire 13. The base 50 may have a top surface equipped with the cylinder magnet 40. The base 50 may have a center hole 50a, which may be a through hole extending through the base 50. The base 50 may have a bottom surface equipped with at least one pin 52 extending perpendicularly to the bottom surface. In the example, the base 50 may be equipped with four pins 52 arranged to surround the center hole 50a. The pin 52 may be formed of or coated with electrically conductive material such as metal. The base 50 and the pin 52 may be formed of electrically conductive material such as metal.

In another example, the base 50 and the pins 52 may be integrally molded of resin such as ABS resin. The pin 52 may be electrically conducted with a ground line of the electronic module 30 to render the pin 52 to have conductivity.

The spring 80 may be a coil spring formed of, for example, metal.

The bezel 60 may be integrally molded of resin such as ABS resin. The bezel 60 may be in a disc shape having a peripheral portion 62 and a bezel center 64. The bezel center 64 may be dented from the peripheral portion 62. The bezel center 64 may have a flat top surface equipped with a bar 70. The bar 70 may have a bar body 72 and a bar head 74. The bar head 74 may be greater than the bar body 72 in diameter. The bar head 74 may have chamfered surfaces. The bar 70 may have a center slit 70a and may be retractable in the radial direction when receiving a radial compression force to reduce the center slit 70a. The bezel center 64 may have holes 64a, which may be through holes extending through the bezel center 64. In the present example, the bezel center 64 may have four holes 64a correspondingly to the four pins 52 of the base 50.

The bezel 60 may be integrally formed of resin together with brackets 66 and clips 68. The brackets 66 may extend from both sides of the bezel 60, respectively, outward in the radial direction. The clips 68 may extend further form the brackets 66, respectively, and bent at an angle such as a right angle. Each of the clips 68 may have a nail 69 bent at an angle, such as a right angle, to extend inward from the clip 68 in the radial direction. The bracket 66, the clip 68, and the nail 69 may form a C-shape. The brackets 66 may be cantilevered from the lateral sides of the bezel 60.

As follows, assembly of the components will be described. First, the spring 80 may be attached to the bar 70. Specifically, the bar head 74 and the bar body 72 may be inserted through a center hollow of the spring 80. Subsequently, the base 50 may be affixed to the bar 70. Specifically, the center hole 50a of the base 50 may be aligned with the bar head 74, and the pins 52 may be aligned with the holes 64a of the bezel center 64. Subsequently, the base 50 may be press-fitted to the bar 70. As the base 50 is press-fitted onto the bar head 74, a brim of the center hole 50a of the base 50 may urge the chamfered surface of the bar head 74 thereby to resiliently squash the bar head 74 radially inward. Thus, the bar head 74 may be reduced in diameter to pass through the center hole 50a of the base 50. After the bar head 74 passes through the center hole 50a of the base 50, the bar head 74 resiliently recover its shape to latch the base 50 on the bezel center 64 via the spring 80.

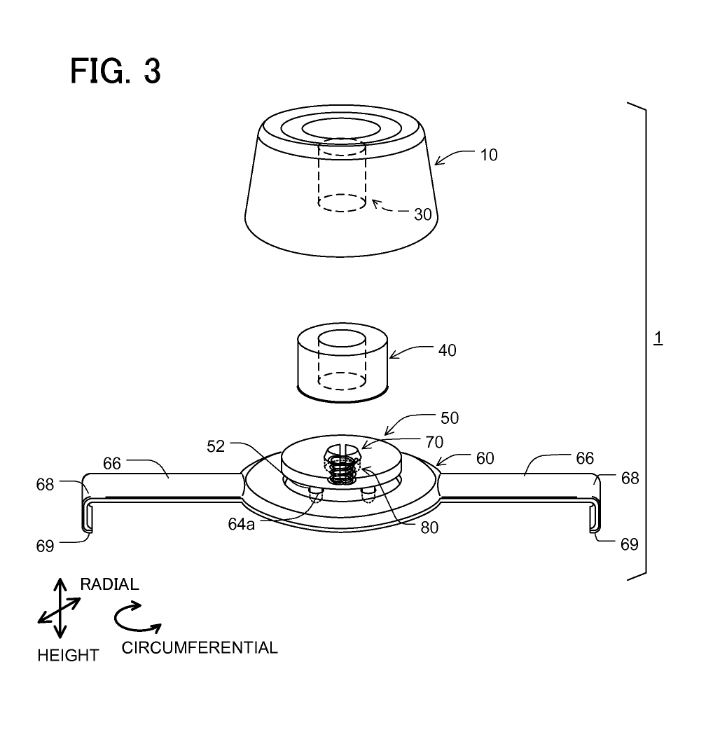

FIG. 3 shows the state where the base 50 is attached to the bezel 60 via the spring 80. The base 50 may be linearly movable in the height direction against resilience of the spring 80. As a pressing force is applied onto the base 50 toward the bezel 60, the pins 52 may be projected through the holes 64a of the bezel center 64. As the pressing force is released, the spring 80 may resiliently push back the base 50 away from the bezel 60, and the pins 52 may be retracted into the holes 64a. The bar head 74 may latch the base 50 to restrict the base 50 from being detached from the bar 70.

The cylinder magnet 40 may be mounted to the top surface of the base 50 by, for example, press-fitting and/or bonding. In another example, the cylinder magnet 40 may be mounted to the base 50 in advance before the base 50 is mounted to the bezel 60.

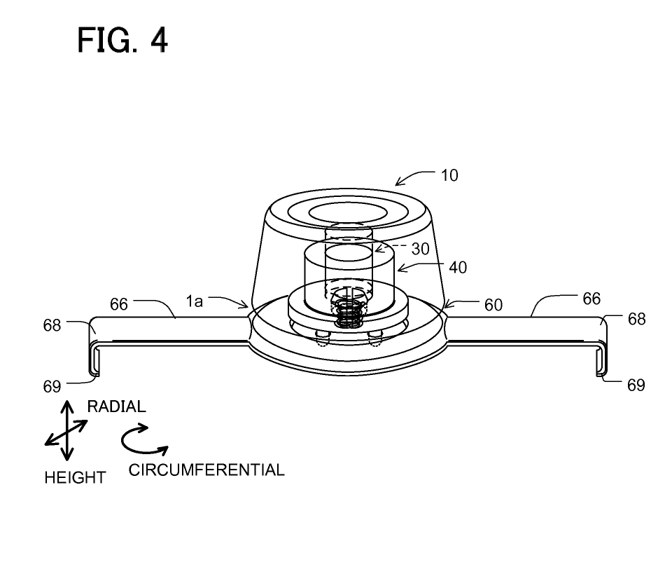

FIG. 4 may show the knob 10 mounted to the cylinder magnet 40. In the present state, the knob 10 may be rotational relative to all the cylinder magnet 40, the base 50, and the bezel 60, which are integrated with each other. The knob 10 may be floated from the top surface of the bezel 60 to form a gap 1a therebetween. The knob 10 may be resiliently movable by a movable distance within the gap 1a.

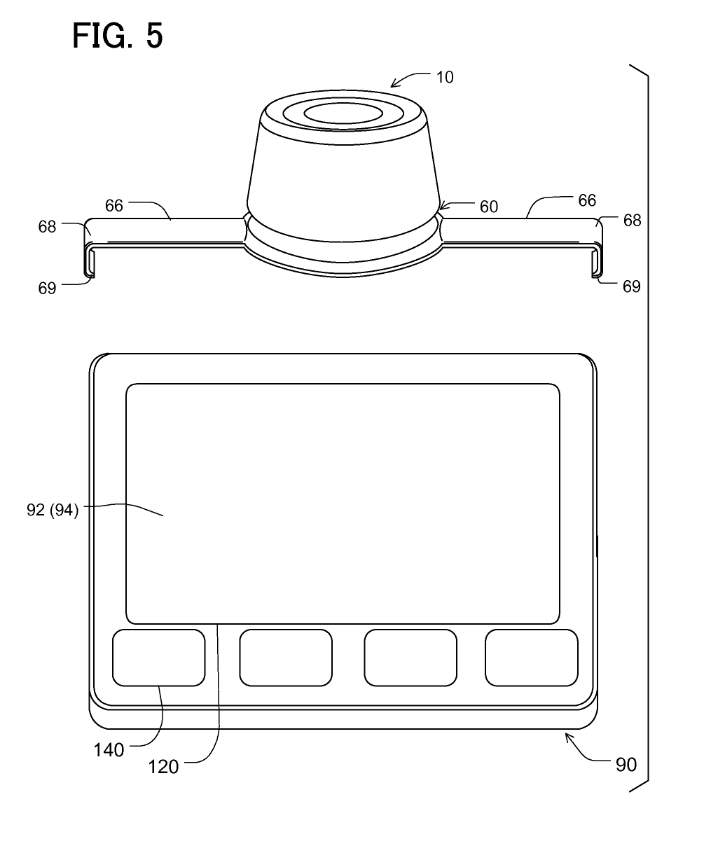

As shown in FIG. 5, the operational device 1 may be attachable to a display device 90. The display device 90 may be, for example, an infotainment device such as a smart phone, a tablet, a portable data assistant, or a vehicular portable device. The vehicular portable device may be a multifunctional key fob or a key device for a vehicle. The display device 90 may have a screen 92 configured to show various indications. The display device 90 may be, for example, an LCD display or an organic EL display having, for example, a full-color dot-matrix configuration having multiple pixels, which may be selectively activated. The display device 90 may be configured to indicate, for example, a main console 120 and icons 140. The screen 92 may be protected with a translucent shield grass to form a flat surface entirely. The screen 92 may be equipped with a touch sensor 94 (haptic sensor) to enable a user to manipulate a function of the display device 90 by touching the screen 92. The touch sensor 94 may have a capacitive sensor to detect multiple points at which pressure is applied. The touch sensor 94 may have a multi-touch configuration to accept multiple touch points simultaneously. The touch sensor 94 may employ various configurations such as a resistive sensor, an optical sensor, a SAW sensor, and/or a pressure-sensitive configuration.

The display device 90 may include a controller 190, which may be a microcomputer configured with a CPU and a storage device for implementing various processings such as execution of an application.

The operational device 1 may be attached onto the display device 90. Specifically, one of the clips 68 and nails 69 may be hooked to one lateral side of the display device 90. A user may use fingers to expand the other of the clips 68 and nails 69 resiliently outward to enable the other lateral side of the display device 90 to reside inside the other clip 68 and nail 69. The user may release the other clip 68 and nail 69 thereby to allow the other clip 68 and nail 69 to fit resiliently onto the other lateral side of the display device 90.

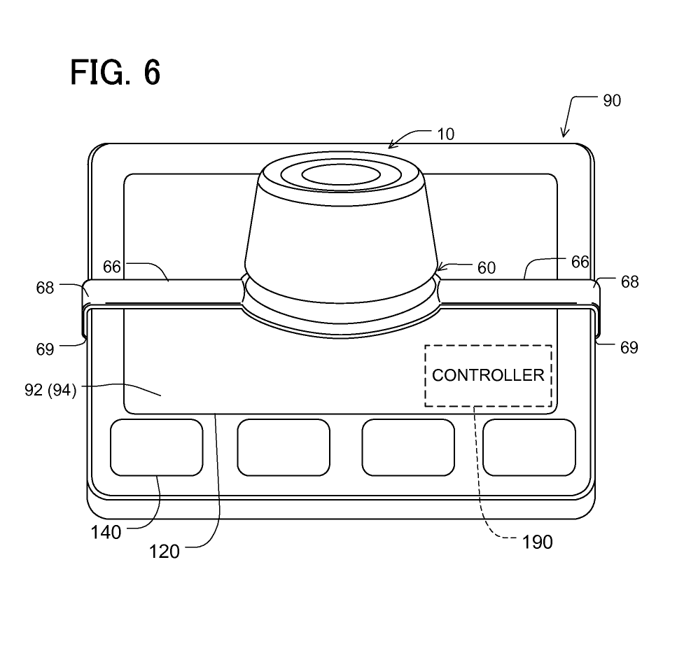

Thus, as shown in FIG. 6, the operational device 1 may be clipped (snap-fitted) on the display device 90. The bezel 60 and the knob 10 may be supported by the clips 68 and the nails 69 via the brackets 66 at both sides. In the present state, the operational device 1 may be on the main console 120, which is initially indicated on the screen 92.

A user may manipulate a configuration setting of the display device 90 to pair the display device 90 with the communicator 38 (FIG. 2) of the operational device 1 thereby to enable the operational device 1 to exchange a signal with the display device 90. Thus, the operational device 1 may be enabled to send a detection signal of the encoder 36 to the display device 90 to enable the display device 90 to recognize the rotational position of the knob 10.

A user may further activate an application software (application) by, for example, touching an icon on the screen 92 of the display device 90. The application may be bundled with the operational device 1 and may be downloaded and/or may be installed on the display device 90 by a user. The application may inquire a user about information, which specifies the operational device 1 such as a model number. The user may enter the inquired information thereby to render the display device 90 recognize the specification of the operational device 1, such as a dimension and/or a function of the operational device 1. Specifically, the display device 90 may retrieve the size of the bezel 60 and brackets 66 from a database stored in the display device 90 or from the Internet.

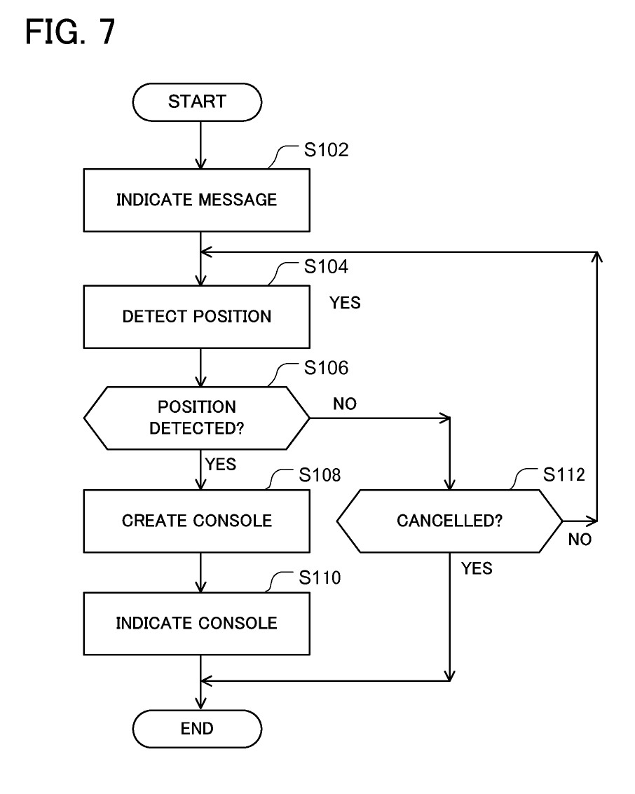

FIG. 7 shows a processing corresponding to the application. The controller 190 of the display device 90 may execute the processing. At S102, the controller 190 may cause the display device 90 to show a message to prompt a user to press the knob 10. The message may be indicated with a cancel button. At S104, the controller 190 may cause the display device 90 to detect a position of the operational device 1. At S106, the controller 190 may determine whether the screen 92 detects the position of the operational device 1. When S106 makes a positive determination, the processing may proceed to S108 at which the controller 190 may cause the display device 90 to create a console to be indicated on the screen 92. Subsequently, at S110, the controller 190 may indicate the console on the screen 92, and the processing may terminate. When S106 makes a negative determination, at S112, the controller 190 may determine whether the cancel button is touched by a user. When S112 makes a positive determination, the processing may terminate. When S112 makes a negative determination, the processing may return to S104.

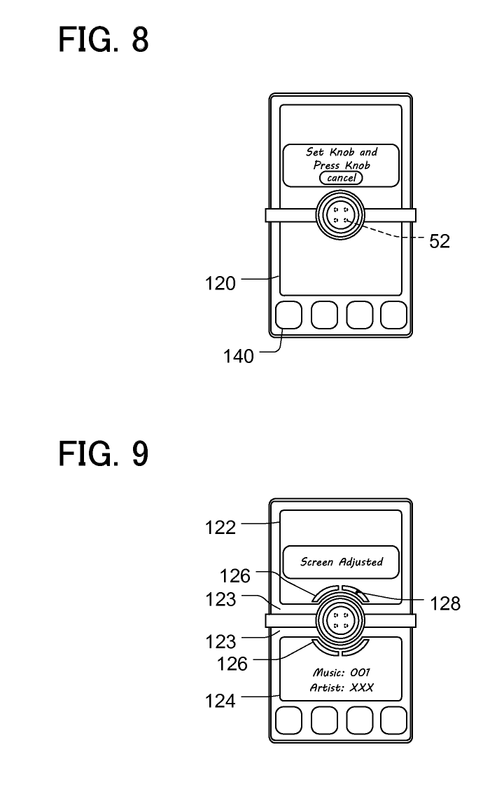

FIGS. 8 and 9 may show a first example in which the operational device 1 is attached to the display device 90 at a first position. In FIG. 8, when the user activates the application, the display device 90 may show the message, which is to prompt a user to press the knob 10, and the cancel button. The display device 90 may cause the screen 92 to begin to detect the position of the operational device 1. Specifically, the screen 92 may detect touch, depression, and/or proximity of objects on the screen 92 at four positions corresponding to the four pins 52 of the operational device 1.

When a user pushes the top wall 12 of the knob 10 with a finger, the operational device 1 may project the pins 52 toward the screen 92 (refer to FIG. 1), thereby to touch, depress, and/or approach the screen 92 at the four positions. In response, the display device 90 may determine that the operational device 1 is located at a position to surround the four positions of the pins 52.

The display device 90 may create a first console 122 and a second console 124 based on the detected position. For example, the display device 90 may calculate a size and a position of the first and second consoles 122 and 124 by adding additional margins 123 based on the dimension of the operational device 1, such that the operational device 1 does not to overlap with the first and second consoles 122 and 124. That is, the display device 90 may split the main console 120 into the first and second consoles 122 and 124. The display device 90 may add an indicator 126 on each of the first and second consoles 122 and 124. The display device 90 may add a scale 128 on the indicator 126 to represent a quantity related to a rotational position of the knob 10.

Subsequently, the display device 90 may indicate the consoles 122 and 124 on the screen 92 to surround the operational device 1. In the example, the first console 122 may indicate a message to notify a user of completion of adjustment of the screen 92. The consoles 122 and 124 may be for playing contents such as a music file stored in the display device 90. The second console 124 may indicate information of the contents such as a title and an artist of the music file. The user may rotate the knob 10 to manipulate various functions such as a sound volume and/or a content of the music file.

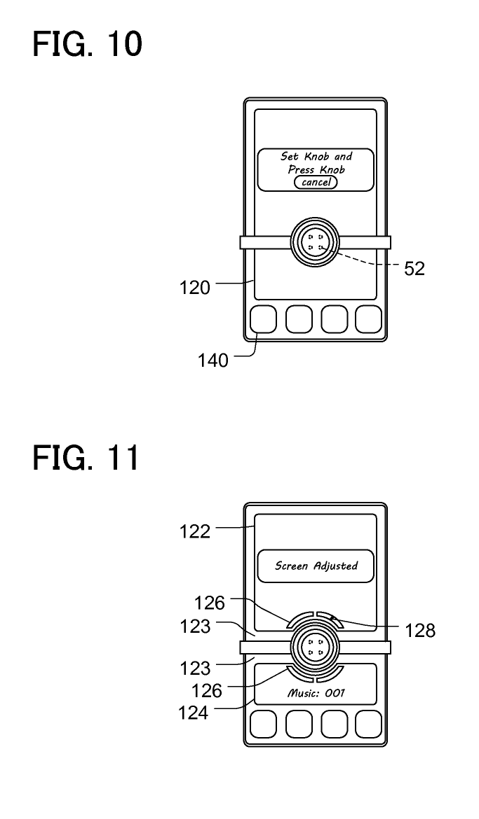

FIGS. 10 and 11 show a second example in which the operational device 1 is attached to the display device 90 at a second position. The second position is lower than the first position of the first example. In the second example, the display device 90 may create the first console 122, which is greater than the first console 122 in the first example, and the second console 124, which is smaller than the second console 124 in the first example to indicate reduced information of the contents, correspondingly to the position of the display device 90.

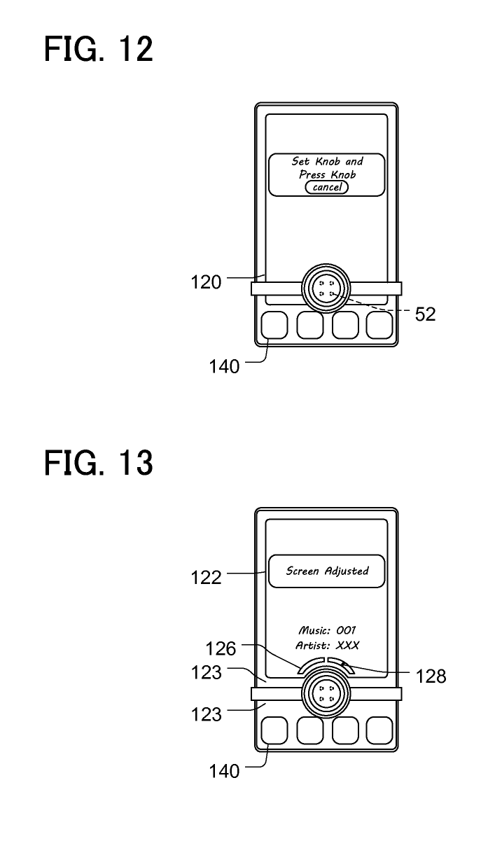

FIGS. 12 and 13 show a third example in which the operational device 1 is attached to the display device 90 at a third position. The third position is further lower than the second position, and the operational device 1 may be proximate to or adjacent to the icons 140. In the third example, the display device 90 may create the first console 122, which is further greater than the first console 122 in the second example, correspondingly to the position of the display device 90. In addition, the display device 90 may not create and may not indicate the second console 124. The display device 90 may leave indication of the icons 140, instead. The first console 122 may indicate the information of the contents.

### Second Embodiment

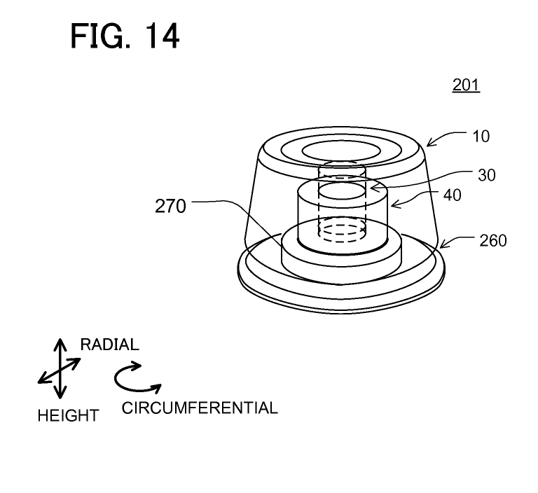

As shown in FIG. 14, an operational device 201 of the example may include the knob 10, the electronic module 30, the cylinder magnet 40, a bezel 260, and a magnet 270.

The magnet 270 may be affixed to the bezel 260. The cylinder magnet 40 may be affixed on the magnet 270. The magnet 270 may be accommodated partially or entirely in the knob 10. The electronic module 30, the cylinder magnet 40, and the magnet 270 may be coaxial with each other. The magnet 270 may be a permanent magnet formed of, for example, neodymium in a disc shape. The magnet 270 may generate attractive force and may stick to a magnetic component such as a ferrous component. The operational device 201 may be attached onto various devices, which is configured with the magnetic component, such as an infotainment device, a dashboard of a vehicle, a home appliance, and/or the like. The electronic module 30 of the operational device 201 may be paired with various devices in a wireless manner. The operational device 201 may be detached from a device, which is currently paired with the operational device 201, and may be attached to another device. The operational device 201 may be paired with the other device. Thus, a user maybe enabled to manipulate the other device.

The knob 10 and the electronic module 30 may be replaceable with the cylinder magnet 40, the base 50, and the bezel 60 of the first embodiment.

### Third Embodiment

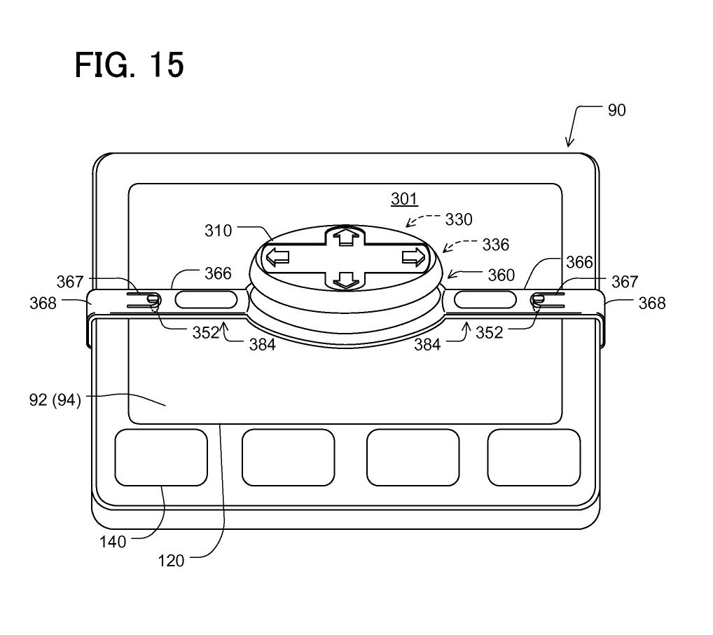

As shown in FIG. 15, an operational device 301 of the example may include a cross key 310, an electronic module 330, and a bezel 360. The cross key 310 may function as an operational element.

The cross key 310 may be in a disc shape. The electronic module 330 may be accommodated in the cross key 310 and may have the same function as the electronic module 30 of the first embodiment. The cross key 310 may have four arrow keys corresponding to four directions. The cross key 310 may be pivoted by the bezel 360 and may be configured to press an internal switch (encoder) 336 when a corresponding arrow key is depressed by a user. The internal switch 336 may be connected with the electronic module 330 and may send a signal to the electronic module 330. Thus, the electronic module 330 may detect depression of the arrow key and may transmit a signal representing the depressed arrow key to the display device 90, when the electronic module 330 is paired with the display device 90. For example, a user may manipulate the operational device 1 to instruct a direction to move a cursor on the screen 92.

The bezel 360 may be integrally molded with brackets 366 and clips 368. The brackets 66 may have a solar cell 384, which is electrically connected with the electronic module 330 to supply electric power to the electronic module 330.

The bracket 366 may have a pin 352 and an arm 367. The arm 367 may be cantilevered from the bracket 366. The pin 352 may be formed of conductive material such as metal and may be inserted in a through hole formed in one end of the arm 367. Thus, the arm 367 may support the pin 352 at the one end. When the application of the display device 90 is activated, at S104 in FIG. 7, the display device 90 may detect the positions of the pins 52. A user may press bottom ends of the pins 352 to bend the arms 367 and to move the pins 352 downward thereby to depress or to approach the screen 92. Thus, at S106, the display device 90 may detect the position of the operational device 1.

### Fourth Embodiment

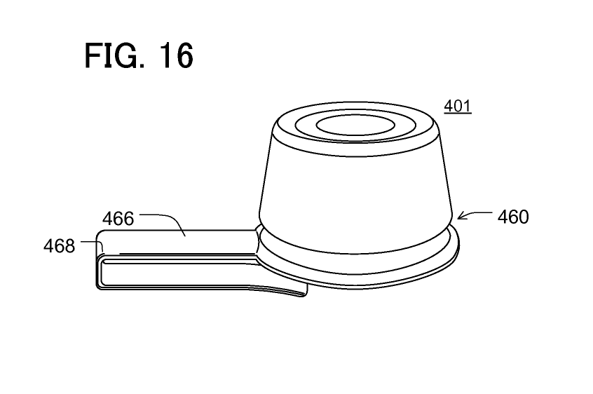

As shown in FIG. 16, a bezel 460 of an operational device 401 of the example may include one bracket 466 and one clip 468. The operational device 401 may be cantilevered when equipped to the display device 90.

### Other Example

In another example, the bracket, the clip, and/or the nail may be adjustable in length.

The number of the pins may be a number other than four. The number of the brackets and the clips may be three or more.

The pin is one example to cause the touch sensor to detect the position of the operational device. For example, a pad may be employed instead of the pin. The pin and/or pad may be configured to change a capacitance on the touch sensor to enable the touch sensor having a capacitance sensitive configuration to detect the position.

The embodiment may be partially or entirely replaced and/or combined with each other.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it may be to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An operational device comprising:
an operational element configured to receive manipulation;
an encoder configured to detect the manipulation of the operational element and to send a detection signal representing the manipulation;
a bezel configured to receive the operational element; and
at least one clip coupled with the bezel and configured to be affixed to a screen of a display device.

2. The operational device of claim 1, further comprising:
at least one bracket extending from the bezel to one of the at least one clip.

3. The operational device of claim 2, wherein
the at least one clip includes two clips, and
the at least one bracket includes two brackets extending from lateral sides of the bezel to the clips, respectively.

4. The operational device of claim 1, further comprising:
at least one pin coupled to the bezel, wherein
the at least one pin is configured to be protruded from the bezel.

5. The operational device of claim 1, wherein
the at least one pin includes a plurality of pins, and
the pins are arranged at predetermined positions.

6. The operational device of claim 4, further comprising:
a spring located between the operational element and the bezel to resiliently support the operational element, wherein
the operational element is configured to move the at least one pin to protrude from the bezel when the operational element is pressed against resiliency of the spring.

7. The operational device of claim 1, further comprising:
at least one pin coupled to the bracket; wherein
the at least one pin is configured to be protruded from the bracket.

8. The operational device of claim 1, wherein
the operational element is a knob being hollow and accommodating the encoder, and
the knob is rotational relative to the bezel.

9. The operational device of claim 1, wherein
a communicator configured to communicate with an other device in a wireless manner and to send the detection signal from the encoder to the other device.

10. The operational device of claim 1, further comprising:
a battery configured to store electric power, wherein
the battery is electrically connected with the encoder.

11. The operational device of claim 1, further comprising:
a solar cell configured to supply electricity to the battery.

12. The operational device of claim 8, further comprising:
a cylinder magnet coupled with the encoder and configured to generate magnetic flux to the encoder, wherein
the encoder is configured to detect the magnetic flux to detect the rotational position of the knob.

13. A graphic image controller comprising:
a detection unit configured to detect a position of an operational device on a screen, which is detachably mounted on the screen; and
a graphic unit configured to create a graphic image according to the detected position and to cause the screen to indicate the created graphic image.

14. The graphic image controller of claim 13, wherein
the detection unit is further configured receive a detection signal, which represents a combination of a plurality of positions, from a haptic sensor of the screen, and
the detection unit is further configured to detect the position of the operational device according to the combination.

15. The graphic image controller of claim 13, wherein
the graphic unit is configured to create a first console and a second console, which surround the operational device.

16. An operational device comprising:
an operational element configured to receive manipulation;
an encoder configured to detect the manipulation of the operational element and to send a detection signal representing the manipulation;
a bezel configured to receive the operational element;
a communicator configured to communicate with an other device in a wireless manner and to send the detection signal to the other device; and
a magnet equipped to the bezel and configured to be detachably affixed to an external object.
